(19) United States
(12) Patent Application Publication
(10) Pub. No.: US 2008/0284910 A1
(43) Pub. Date: Nov. 20, 2008

(54) TEXT DATA FOR STREAMING VIDEO

(76) Inventors: John Erskine, Austin, TX (US); John Wood, Cedar Park, TX (US); Matthew Gutierrez, Los Angeles, CA (US)

Correspondence Address: KENYON & KENYON LLP, ONE BROADWAY, NEW YORK, NY, 10004, US

(21) Appl. No.: 12/023,519

(22) Filed: Jan. 31, 2008

Related U.S. Application Data
(60) Provisional application No. 60/898,790, filed on Jan. 31, 2007.

(51) Int. Cl. H04N 7/00

(52) U.S. Cl. 348/468; 348/E07.001

(57) ABSTRACT

In a system and method providing a video with closed captioning, a processor may: provide a first website user interface adapted for receiving a user request for generation of closed captioning, the request referencing a multimedia file provided by a second website; responsive to the request: transcribe audio associated with the video into a series of closed captioning text strings arranged in a text file; for each of the text strings, store in the text file respective data associating the text string with a respective portion of the video; and store, for retrieval in response to a subsequent request made to the first website, the text file and a pointer associated with the text file and referencing the text file with the video; and/or providing the text file to an advertisement engine for obtaining an advertisement based on the text file and that is to be displayed with the video.

### CROSS-REFERENCE TO RELATED APPLICATIONS

This application claims priority to U.S. Provisional Application No. 60/898,790, filed Jan. 31, 2007, which is incorporated herein by reference in its entirety.

### COPYRIGHT

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### FIELD OF THE INVENTION

The present invention relates generally to streaming video technology and more specifically to the inclusion of text or closed captioning information to network-based-distributed streaming video.

### BACKGROUND

There are various existing techniques and systems for closed captioning. Most techniques are based on the technique of embedding the closed captioning text in a vertical blanking interval (VBI). This technique allows for conventional televisions to decode the encoded closed captioning text embedded in the VBI and superimpose the text on top of the television image in the bottom portion of the television screen.

VBI-inserted closed captioning works primarily in broadcast-based video distribution. Other techniques are known for other types of closed captioning, such as a closed captioning track used in a DVD.

Streaming multimedia content including video content is a new trend in the field of distribution of multimedia data, e.g., including video content. Using streaming multimedia technology, a multimedia data and/or video content provider, e.g., YouTube.com, or any news websites, may constantly deliver content, e.g., video, which may be normally displayed to end users over a communication network, e.g., the Internet. However, even though the streaming multimedia technology continues to grow, technologies to provide streaming multimedia or video with closed captioning have not kept pace in the sense that the majority of multimedia or video contents on the Internet provide no closed captioning capability. This may be a significant disadvantage for people who need closed captioning, e.g., the hearing impaired. This may also be a major shortcoming for users who may wish to watch streaming video without sound, but may still want to follow any dialogue.

One conventional technique to include closed captioning in a streaming multimedia data including video is to capture the closed captioning already turned on, e.g., on a television screen, and then post the program on a streaming video hosting web site. During the recording process, the closed captioning may be enabled and the closed captioning may be recorded as part of the visual output. While this approach may provide closed captioning, it may be limited only to videos that have been recorded with closed captioning turned on. Additionally, since streaming multimedia or video may provide limited screen resolution, e.g., typically 352×240 under Motion Picture Experts Group-1 (MPEG 1) video standard, the closed captioning captured in this way may not be easy for a human end user to view.

Additionally, conventional techniques may be limited to captured multimedia or video content by providers that provide closed captioned capability. However, many streaming multimedia or videos, e.g., home videos, are generated by providers who lack the underlying capabilities for closed captioning, and therefore, these content are not provided with closed captioning.

Another recent trend is that a person, e.g., a content provider who wants to provide a synopsis of the content or a viewer who wants to provide a review of the content, may insert comments or other types of text for a streaming multimedia or video. For example, a person may embed a text field with comments or tie comments to the video in a secondary screen. This technique, however, is unrelated to closed captioning. For example, the entered commentary text does not correspond to the audio of the provided content. Since these comments are also tied to the multimedia or video streaming as seen through the browser that enabled the comments, comments on a video on a first web site may not be viewable on a second web site. Even if the comments may be seen at a second website, the comments are provided in a spontaneous way that may not be synchronized with the audio.

Conventional Internet content providers or search engines, e.g., Google.com and Yahoo.com, supply advertisements via an advertisement broker based on the content, e.g., text, of a webpage. For example, the advertisements may be selected because of their relevance to assumed user personal interests associated with the text. This technique, commonly referred to as targeted advertisement, may generate higher revenues for the Internet content providers or search engines. However, video contents commonly contain only limited useful information, e.g., title or metadata, on which to base a selection of advertisements.

### SUMMARY

Existing closed captioning techniques do not accommodate streaming video technology well. Embodiments of the present invention provide techniques for enabling and distributing closed captioning information with the distribution of streaming video, which may include distributing the streaming video across the Internet or any other network-based distribution system.

With the prevalence of video portals, e.g., YouTube.com, any user or company may upload multimedia content including video to a portal website. It is difficult to systematically track where video content are located. Further, even if all of the content could be tracked and found, generation of closed captioning text for all found video content can place an extremely large processing load on a closed captioning generation system. Example embodiments of the present invention provide a system and method for providing an interface via which users may submit requests for closed-captioning text generation for referenced video content, so that tracking video content would not be required and so that closed-captioning is selectively generated for only those videos for which an indication has been received that there is a desire for closed-captioning. Example embodiments of the present invention may store the closed-captioning text generated in response to such requests for retrieval in response to subsequent requests therefor.

In an example embodiment of the present invention, a method for providing a video with closed captioning may include: providing, by a first website, a user interface adapted for receiving a user request for generation of closed captioning text, the request referencing a multimedia data file including the video and provided by a second website; and, responsive to the user request: at least substantially transcribing audio associated with the video into a series of closed captioning text strings arranged in a text file; for each of the text strings, storing in the text file respective data associating the text string with a respective portion of the video; and storing, for retrieval in response to a subsequent request made to the first website, the text file and a pointer associated with the text file and referencing the multimedia data file.

In an example embodiment of the present invention, a method for providing streaming multimedia data, including a streaming video associated with audio, with closed captioning to an end user for synchronous display may include: in response to an end user request for closed captioning of the streaming multimedia data accessible at a video portal, providing the request to a closed captioning generation entity, where the streaming multimedia data may be examined based on a set of factors for a determination as to whether to generate closed captioning data for the streaming multimedia data; and, if the determination is to generate the closed captioning data, transcribing audio of the streaming multimedia data into a series of closed captioning text strings, where each closed captioning text string is time-stamped according to the corresponding audio and the combination of the text strings substantially matches the corresponding audio of the streaming video; providing the closed captioning data to a closed captioning database for storage, associating a closed captioning data source identifier identifying the closed captioning data with a streaming multimedia data source identifier identifying the streaming video, providing the streaming multimedia data source identifier and the closed captioning data source identifier to a closed captioning server; and notifying the end user of an availability of the closed captioning data in a closed captioning video portal.

In an example embodiment of the present invention, the method may further include: in response to the notification of the availability of the closed captioning data, sending to the closed captioning video portal an end-user-generated request for a closed captioned streaming multimedia data, where the end-user-generated request may include the closed captioning data source identifier and the streaming multimedia data source identifier; retrieving the closed captioning data according to the closed captioning data source identifier and the streaming multimedia data according to the streaming multimedia data source identifier; and playing the multimedia data in a multimedia data frame and the corresponding closed captioning text in a closed captioning text frame.

In an example embodiment of the present invention, the notification to the end user may be an e-mail to the end user including a HTML link, activation of which may provide the end user access to the closed captioning video server.

In an example embodiment of the present invention, the method may further include: assigning to the streaming video cue points at regular intervals of the streaming video; and playing the streaming video, where at the cue points, a remote caption player embedded in the closed captioning video portal may generate events that synchronously trigger updates of the closed captioning text in the closed captioning text frame.

In an example embodiment of the present invention, the method may further include: providing the closed captioning text to an Internet advertisement engine which may return an advertisement retrieved from an advertising database based on the closed captioning text; and providing the advertisement to the end user along with the streaming video. In an example embodiment of the present invention, the advertisement engine may be the Google's AdSense service.

In an example embodiment of the present invention, the closed captioning data may include a closed captioning text file and a metadata, where the metadata may provide information regarding the streaming multimedia data. In a variant example embodiment of the present invention, the metadata may include information relating to one or more of a name of a television show contained in the streaming multimedia data, an original air date of the television show, and a summary of the show.

In an example embodiment of the present invention, the closed captioning generation entity may include human operators for experiencing the streaming multimedia data who may be either co-located with or located separately from the closed captioning server. In an alternative embodiment of the present invention, the closed captioning generation entity may be a system that includes a speech-to-text program for generating the closed captioning in real time while the video is playing.

In an example embodiment of the present invention, the set of factors to determine whether to proceed with closed captioning may include the vocabulary in closed captioning text, the content, and the nature of the streaming multimedia data.

In an example embodiment of the present invention, the end user may be identified to the closed caption video server by logging into an end-user-created account at the closed captioning video portal.

In an example embodiment of the present invention, the end user may submit the request for closed captioning in a text dialog box at the closed captioning video portal.

In an example embodiment of the present invention, a method for providing a streaming multimedia data, including video and associated audio, with closed captioning text to an end user for synchronous display may include: responsive to a closed captioning generation request: transcribing the audio into a series of closed captioning text strings, where each of the closed captioning text strings may be time-stamped according to corresponding audio of the multimedia data and the combination of the text strings substantially matches the corresponding audio of the multimedia data; providing the closed captioning data to a closed captioning database for storage; associating a closed captioning data source identifier identifying the closed captioning data with a streaming multimedia data source identifier identifying the multimedia data; providing the streaming multimedia data source identifier and the closed captioning data source identifier to a closed captioning server; notifying the end user of an availability of the closed captioning data in a closed captioning video portal; providing the closed captioning text to an Internet advertisement engine which may return an advertisement retrieved from an advertising database based on the closed captioning text; and providing the advertisement to the end user along with the streaming multimedia data.

In an example embodiment of the present invention, a method for providing a display of a streaming video may include transcribing audio associated with the video into a text file, providing the text file to an Internet advertisement engine for obtaining an advertisement based on the text file, and displaying the advertisement along with the video.

In an example embodiment of the present invention, a system for providing a streaming video with closed captioning text delivered to an end user for synchronous display may include: a closed captioning database; a closed captioning server; a closed captioning generation system; and a closed captioning processing unit configured to, in response to an end user request for close captioning of the streaming multimedia data including the streaming video accessible at a video portal, provide the request to the closed captioning generation system and notify the end user of the availability of the closed captioning data in a closed captioning video portal, the closed captioning generation system configured to: examine the streaming multimedia data based on a set of factors for a determination as to whether to generate a closed captioning data for the streaming multimedia data and, if the determination is to generate the closed captioning data, transcribe audio of the streaming multimedia data into a series of closed captioning text strings, wherein each of the closed captioning text strings may be time-stamped according to the corresponding audio and the combination of the text strings substantially may match the corresponding audio of the streaming multimedia data; provide the closed captioning data to the closed captioning database for storage; associate a closed captioning data source identifier identifying the closed captioning data with a streaming multimedia data source identifier identifying the streaming multimedia data; and provide the streaming multimedia data source identifier and the closed captioning data source identifier to the closed captioning server.

In an example embodiment of the present invention, a system for providing a streaming video with closed captioning text to an end user for synchronous display may include: a closed captioning database; a closed captioning generation system; a closed captioning server; and a closed captioning processing unit configured to: in response to an end user request for close captioning of the streaming video accessible at a video portal, provide the request to the closed captioning generation system; notify the end user of the availability of the closed captioning data in a closed captioning video portal; and provide the closed captioning text to an Internet advertisement engine which may return an advertisement retrieved from an advertising database based on the closed captioning text and provide the advertisement to the end user along with the streaming video, the closed captioning generation system configured to: transcribe audio associated with the streaming video into a series of closed captioning text strings, where each of the closed captioning text strings may be time-stamped according to the corresponding audio and the combination of the text strings substantially matches the corresponding audio associated with the streaming video; provide the closed captioning data to the closed captioning database for storage; associate a closed captioning data source identifier identifying the closed captioning data with a streaming video source identifier identifying the streaming video; and providing the streaming video source identifier and the closed captioning data source identifier to the closed captioning server.

### BRIEF DESCRIPTION OF THE DRAWINGS

FIG. 1 illustrates a block diagram of a system for generating closed captioning information for streaming video, according to an example embodiment of the present invention.

FIG. 2 illustrates a workflow diagram of the operations of the system of FIG. 1, according to an example embodiment of the present invention.

FIG. 3 illustrates a block diagram of a system for distributing closed captioning information with streaming video, according to an example embodiment of the present invention.

FIG. 4 illustrates a workflow diagram of operations of the system of FIG. 3, according to an example embodiment of the present invention.

FIG. 5 illustrates a workflow diagram of operations of the system of FIG. 3, according to another example embodiment of the present invention.

FIG. 6 illustrates a sample graphical representation of data stored in a processing unit database, according to an example embodiment of the present invention.

FIG. 7 illustrates a block diagram of distribution of closed captioning information and advertising information, according to an example embodiment of the present invention.

FIGS. 8-11 illustrate sample screen shots of distribution of closed captioning information with streaming video, according to example embodiments of the present invention.

### DETAILED DESCRIPTION

Text-based information regarding the audio content associated with a streaming video can be generated by an initial recognition procedure, e.g., transcription of the audio by human operators or speech-to-text routines, e.g., Dragon Naturally Speaking® by Nuance. The generated text information based on the audio content, commonly referred to as closed captioning, may then be stored in a data storage, e.g., a MySQL database, with a reference to the corresponding streaming multimedia or video. When an end user wishes to view a streaming multimedia or video, the retrieval of the streaming video may also trigger the launching of the retrieval of the text information. The user may then be presented with both the streaming multimedia or video content and the corresponding text information.

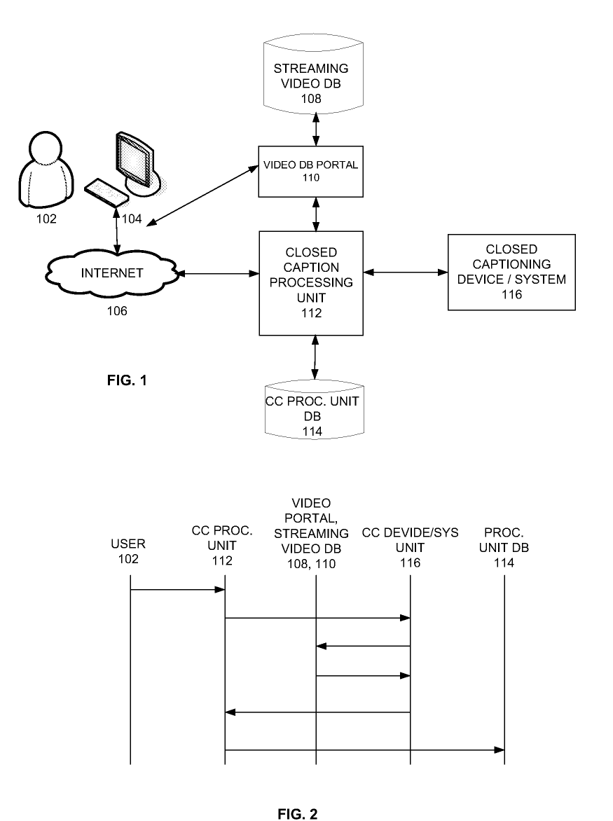

FIG. 1 illustrates a system where an end user 102, through a terminal 104 connected to the Internet 106, may select a multimedia file at a multimedia database portal 110 for text generation according to an example embodiment of the present invention. A web portal is a webpage that may function as a point of access to diverse information on the Internet. The multimedia database portal 110 may include access points, e.g., Hypertext Markup Language (HTML) links to multimedia content, including videos, that may be provided to end users via data streaming. The multimedia database portal 110 may include software applications that may store video content in, e.g., one or more streaming video databases 108 according to instructions executed by a database processing device that may or may not be separate from the processing device contained in the processing unit 112, discussed below. By way of example, the multimedia portal may be a web site, e.g., YouTube.com, that contains HTML links to diverse video content hosted in, e.g., a streaming video database 108, and may allow an end user to receive these streaming videos through the video portal using a media player, e.g., Microsoft Media Player or RealNetworks RealPlayer, which may be capable of displaying streaming content on the end user's terminal 104.

The system may further include a closed caption processing unit 112, which may include one or more processing devices or systems operative to perform processing steps in response to executable instructions, e.g., a Central Processing Unit (CPU) or a Digital Signal Processing (DSP) device programmed to perform processing instructions. The instructions may be stored on a computer-readable medium, e.g., that is implemented via a hardware device, that is accessible to the CPU or DSP.

The end user may access the closed caption processing unit 112 through a closed caption video portal and/or website, which may also include features through which the end user may submit a request, e.g., by submitting the Uniform Resource Locator (URL) of a video content, to the closed caption processing unit for a further processing of the video content, e.g., generating closed captioning from the audio track associated with the video content.

The system may further include a closed captioning entity 116, which may be any suitable device or system for generating the closed captioning text corresponding to the audio of the video content. In one example embodiment, the closed captioning entity 116 may include one or more human operators who transcribe the audio of the streaming video content. The human operators may be physically co-located with the processing unit 112 or at a remote location in communication with the processing unit 112 through a communication network, e.g., the Internet or the telephone network. In an alternative example embodiment, the closed captioning text may be automatically generated using a speech-to-text program, e.g., Dragon's Naturally Speaking®, residing either on the processing unit 112 or on another remote closed captioning device or system in communication with the processing unit 112. The resulting closed captioning text may be stored in a processing unit database 114 accessible by the closed caption processing unit 112.

In an example embodiment of the present invention, the closed captioning text may be automatically generated in real time, while the streaming video is playing after it is selected by an end user. Alternatively, the closed captioning may be generated in response to an user request, e.g., by submitting an Uniform Resource Locator (URL) address of a video content, to the closed caption processing unit which, based on a set of factors, makes a determination whether to proceed with the generation of closed captioning text. Upon generation of the closed captioning text for the requested video, the closed caption processing unit 112 may generate a notice, e.g., in the form of an e-mail embedded with a HTML link directed through the closed caption processing unit 112 to the end user who may access the video with closed captioning through the provided HTML link, activation of which may launch a specially designed caption player, e.g., a Flash media player capable of displaying synchronized video stored, e.g., in the streaming video database 108, and closed captioning text stored, e.g., in the processing unit database 114.

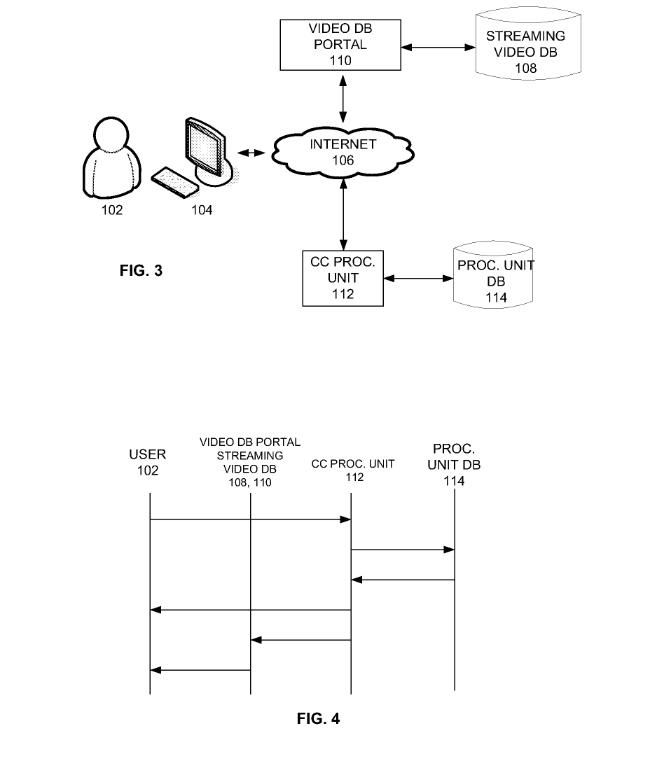

FIG. 2 illustrates an operational flow of events in the system of FIG. 1 according to an example embodiment of the present invention. The end user 102 may view a video content through a video portal 110, e.g., YouTube.com. The video content may reside on a streaming video database 108 accessible via the Internet, e.g., by clicking at a HTML link of the video portal. The end user may select the video for closed captioning by submitting the video content to the closed caption processing unit 112, e.g., by entering the URL at which to obtain the video content in a submission field on the closed caption video portal webpage or directly uploading the video with the request.

In response to the end user request, the processing unit 112 may forward the request for closed captioning of the streaming video content to the closed captioning entity 116. Based on the request, the closed captioning entity 116 may retrieve the streaming video content stored in the streaming video database 108 through the video portal 110 (e.g., where the request references the video in the video database 108). Furthermore, based on a set of factors, e.g., the vocabulary in closed captioning text, the content, the nature of the streaming video, or at the request of the video database portal, the closed caption processing unit 112 or the closed captioning entity 116 may make a decision as to whether to proceed with closed captioning. Upon an affirmation, the closed captioning entity 116 may generate closed caption text based on the audio associated with the streaming video. The generated closed captioning text may be stored as a text file in a format that specifies, e.g., time codes corresponding to the timing of audio, position and font of closed captioning text in a window frame, and text strings corresponding to the audio. The text information may also be readily translated into any number of different languages.

The closed captioning entity 116 may provide the closed captioning text information to the closed captioning processing unit 112, which may thereupon store the text information in the processing unit database 114. As these interconnections between the various components may be across any suitable network, it is understood that there is no proximity requirement for the various components. For example, the closed captioning operation may be performed in another location or country from the end user or the processing unit. Likewise, the end user may be located separately from the processing unit. In one example embodiment, the streaming video database 108 and closed captioning processing unit database 114 may be located at any suitable locations such that the closed captioning processing unit 112, which is accessible via the internet, may retrieve information from both locales.

Using the system of FIG. 1 and the operational steps of FIG. 2, an end user may select a streaming multimedia or video file provided, e.g., as a link in a video portal webpage. This streaming video may then be captioned according to the audio information contained in the streaming video. The text information may reference the streaming video and the processing unit 112 may store this text information in the processing unit database 114. It is also recognized that captioning may be performed on multimedia data files other then video files, including for example audio-based files commonly referred to as Podcasts.

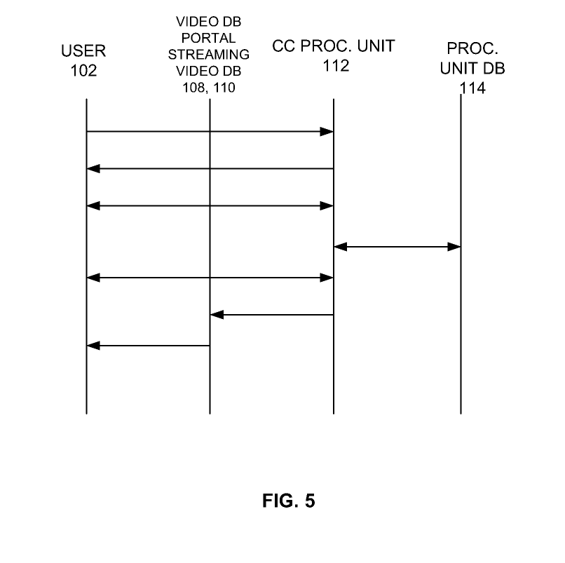

FIG. 3 illustrates an embodiment where an end user seeks to retrieve a streaming video file along with corresponding closed caption. The system of FIG. 3 may include identical components as those contained in FIG. 1, but several components may have been omitted for the sake of clarity. The end user 102, through a terminal 104 and the Internet 106, accesses a closed caption processing unit 112 for viewing a streaming video stored in a streaming video database 108. The terminal 104 may be any suitable device allowing for the receipt of the streaming video, such as for example a personal computer, a mobile computer such as a laptop, a mobile device such as a mobile telephone, personal digital assistant, smartphone, MP3 player with a video screen, a gaming console, a television set-top box or any other suitable processing instrument. Additionally, the terminal 104 may be connected directly to or connectable to any suitable display device, such as a computer monitor, an embedded screen in a mobile device or a television display for devices capable of being connected thereto, for example. The end user 102 may also access the processing unit database 114 containing closed captions to streaming videos, through a closed caption processing unit 112 including a closed caption video portal. As described above, the processing unit database 114 has the textual information, also referred to as closed captioning information, stored therein. The closed captioning information may be stored in a file with an identifier that associates the closed caption information with the corresponding streaming video so that a request for the streaming video at the closed caption video portal may trigger the retrieval of the associated closed captioning information.

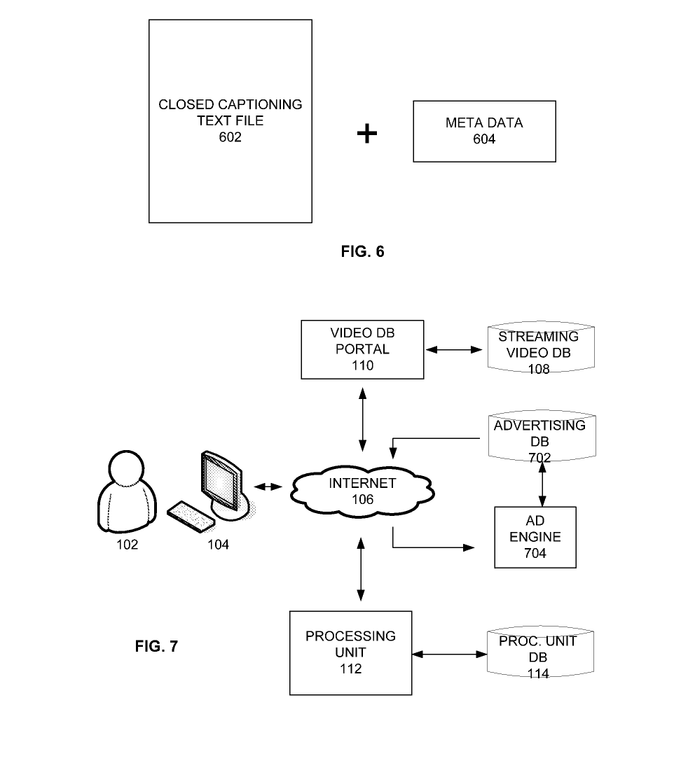

FIG. 4 illustrates a flow diagram of an embodiment of an end user viewing a streaming video with closed captioning information according to one example embodiment of the present invention. The end user 102 may request access to a streaming video at the closed caption processing unit 112 through a closed captioning video portal interface. In one example, the closed caption video portal may include a browser or other type of viewer application where a user may be provided with a selection of closed-caption-enabled streaming videos. In an alternative example, the request for a streaming video may be generated through a HTML link provided to the end user in an e-mail notice in response to the end user's prior request for generation of closed captioning of the streaming video as described above with respect to FIG. 2.

Upon selection, the closed caption processing unit 112 may retrieve the closed captioning information from the processing unit database 114. This closed captioning information may include lines of text strings in a time-stamped sequence to coordinate with the playing of the video. As described in further detail below, the closed captioning information may also include additional types of data for further processing or operations. In one embodiment, the text information may be retrieved through a hyperlink selectable in a browser application where URL-based information may be used for reference and retrieval of the requested text file.

After receiving the closed captioning text information, the processing unit 112 may provide a notice of the availability of the text information to the end user. Based on an identifier provided by the end user, e.g., by the user's logging into a user-created account, the processing unit 112 may also access the video database portal 110 to retrieve the video content such that the streaming video may also be provided to the end user through the closed captioning processing unit 112. In an alternative example embodiment, the processing unit 112 may in addition to, or instead of, the notice provide the text information and/or the video for immediate display.

In an example embodiment, the closed caption processing unit 112 may include a remote caption player or other type of application being executed on the computing device that displays both the streaming video and the text. The display may be provided in a single browser that merges the video and closed captioning. In another embodiment, the text may be displayed in a secondary screen in an overlay position. Various techniques may be used to coordinate the playing of the text and the video, such as having the user select a play button for each of the video and the text, or a browser or viewer recognizing a first play selection and automatically generating the second play selection for the second screen.

In an example embodiment, the text file may be a locally stored file at the end user's computing terminal 104 instead of being streamed concurrent with a corresponding video to the end user. This may be advantageous for situations where for security, foreign language dubbing, or experimentation reasons, the closed captioning text is required to be local. The closed captioning text files may be small files that may be delivered to the end user prior to streaming, e.g., via e-mail. The distribution of the text information and the video to the computing device may be done through a wired or wireless communication channels.

Accordingly, the system of FIG. 3 may provide the end user both a streaming video and the closed captioning information for that video. The closed captioning text file may reference the streaming video so that a user may seamlessly be provided with both types of information. For example, upon selection of a reference to the text file, a pointer to the associated video may be followed for its retrieval. Both may be simultaneously displayed in a synchronous manner, e.g., according to cues or time-stamps of the text file.

As indicated above, the system and method may make a decision as to whether to proceed with generation of closed-captioning. Alternatively, the system and method may make a decision as to whether to provide access to a video and/or its generated closed-captioning text file via the portal website provided by the processing unit 112. The system may provide for filtering the types of videos based on the audio content or the generated closed-captioning text file associated with the video database portal. For example, although user-generated content commonly does not include any standards or ratings for its content, the system may prohibit captioning or refrain from making available a closed-captioning text file of questionable material, and thereby end users may be insured of only being presented with non-offense or otherwise filtered content. The content filtering may be carried out manually by a human operator who is responsible for transcribing the video or automatically using conventional filtering systems.

Additionally, the content of the text file may be utilized separately from the video content, such as allowing a person to e-mail a file, use the file as a transcript or a text document or any other suitable usage, where the formatting of the text file may be determined for various purposes instead of being specifically restricted to a caption player.

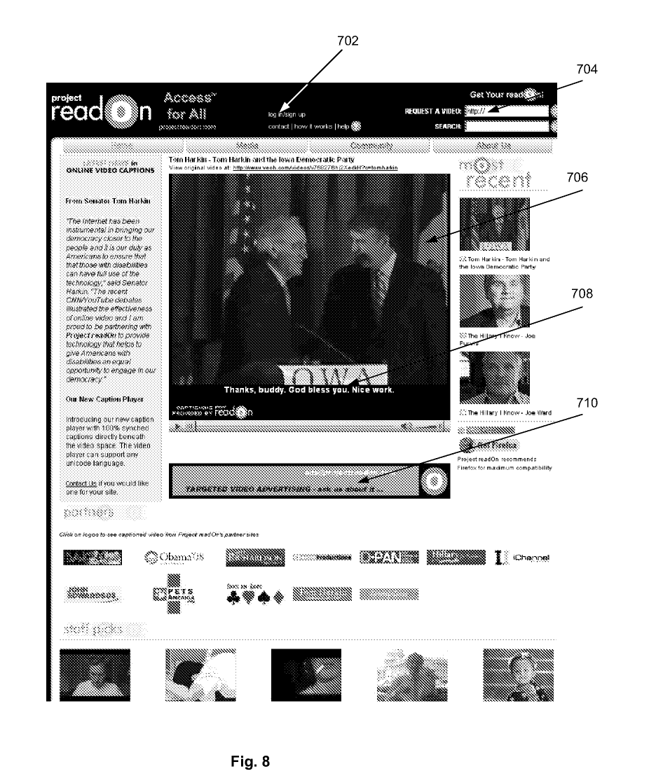

FIG. 5 illustrates a flow diagram of the process to provide the end user with synchronized streaming video with closed captioning according to an example embodiment of the present invention. The end user may submit a Hypertext Transfer Protocol (HTTP) request generated at the user's terminal 104 and made to the closed caption processing unit 112. The generated request may be either for a webpage with an embedded object containing a remote caption player (RCP) provided, e.g., using a Flash Player, or only for an object, e.g., including encoded streaming video and corresponding closed captioning text. The request may include a query string with a unique source identifier corresponding to a streaming video content as well as a language identifier to specify the language of closed captioning text. The closed captioning text can be translated from one language, e.g., English, into multiple different languages, e.g., Spanish and French. The language identifier may specify the type of languages. The closed caption server may provide the webpage and/or the object to the computing terminal 104 for the end user. The RCP from the user's terminal 104 may use, e.g., a Flash function to call, e.g., a Hypertext Preprocessor (PHP) script residing on the closed caption processing unit 112. The PHP script residing on the closed caption processing unit 112 may use the source and language identifiers to search for the requested closed captioning information stored as record in the processing unit database 114, e.g., a MySQL database. In one example embodiment, the closed captioning text is included in the record. In an alternative example embodiment, using a URL stored in the record, the closed caption processing unit may load the closed caption information file, parse it and any other relevant information in the record, and return the information to RCP as POST form data.

The RCP may according to the URL supplied in the POST form data load a video file, e.g., in the form of Flash video .FLV file. In one embodiment, the video file may be located on the closed caption server. In an alternative embodiment, the video file may be located on a third-party video server, e.g., YouTube.com, which is separately located from the closed caption processing unit. The RCP may load the video into, e.g., a Flash MediaDisplay object for video playback. Simultaneously, the RCP may load the returned closed caption data into an array data structure, e.g., the array data structure defined in Flash ActionScript. The RCP may further assign cue points at regular intervals to the video content. When the end user starts the playback, e.g., by pressing a Play button, the cue points may generate events in the RCP which may update the content of a text field, e.g., displayed on the user terminal, to display corresponding captioning text, adjusted in position (left, center, or right) and style (normal or italic).

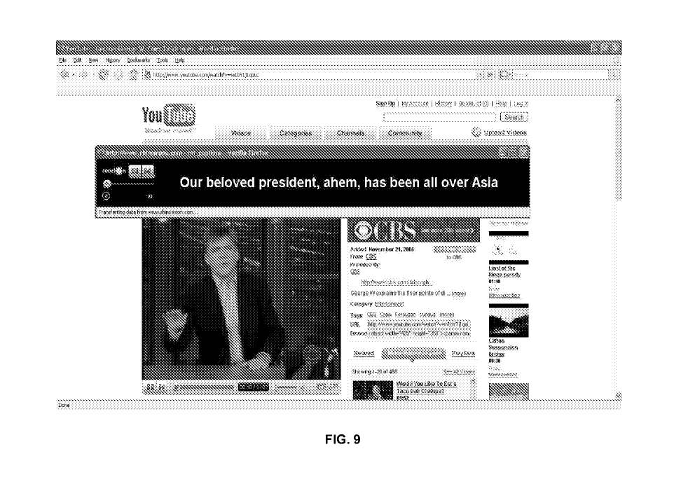

FIG. 6 illustrates the information that may be stored in the processing unit database 114 according to one example embodiment of the present invention. The information may include the closed captioning text file 602 having the text that may be displayed in conjunction with the playing of the video. This text file 602 may be provided for traversal by a search engine, e.g., Google. Additionally, the processing unit database 114 may also store metadata 604 relating to the captioned text. The metadata 604 may provide information regarding the video itself, as well as other information associated with video or text. For example, if the streaming video is a portion of a television show monologue, the metadata 604 may include the name of the show, the original air date, the show's host and information on the content of the monologue.

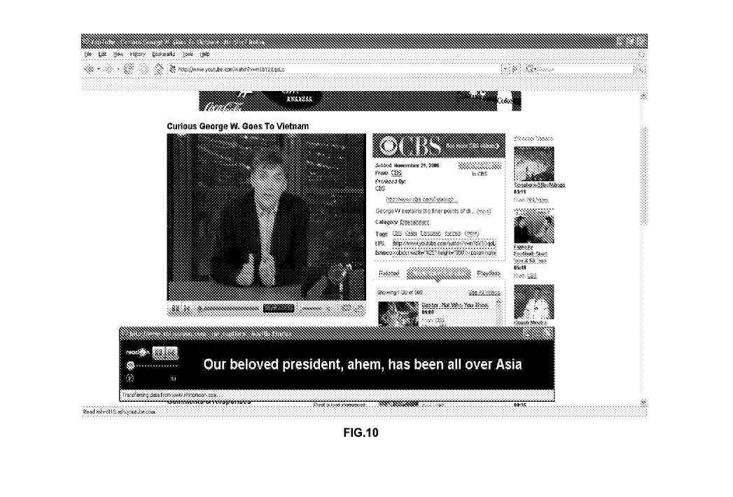

FIG. 7 illustrates a system that may utilize the metadata 604 to provide information for advertisements, according to an example embodiment of the present invention. The system is similar to the system of FIG. 3 but may include an advertising engine 704 and an advertising database 702. The system operates similar to the system of FIG. 3, and may include the additional features of the advertising engine.

In an example embodiment, responsive to a user requesting a streaming video, e.g., that had been previously closed-captioned, the closed caption processing unit 112 may provide the advertising engine 704, e.g., Google's AdSense, with the metadata 604 and/or the text file 602 for the advertising engine to scan the text file 602. Based on the scanned information, the advertising engine 704 may thereupon determine appropriate advertising to be included with the display of the streaming video with or without closed captioning text, and then provide the selected advertisements to be displayed, e.g., on the associated webpage containing the video frame. This determination may be made using any number of suitable techniques as known by those having ordinary skill in the art.

By way of example, the streaming video clip may be a portion of a television show. Advertisers may wish to be associated with particular shows and therefore request their ads to be associated with this video clip. In another example, the advertising may be content driven, such as recognizing a video clip about home improvement based on the closed captioning text and including advertising, e.g., for a home improvement store. Through various techniques, the closed captioning information and/or metadata 604 allows for the inclusion of targeted advertising directed at the end user with the video display.

In another example embodiment of the present invention, while not explicitly shown in FIG. 7, the closed captioning text information and metadata 604 may also be provided to facilitate searching of the streaming video content. For example, this information may allow text-based search engines to include videos when conducting searching operations. Due to the graphical nature, previous searching operations were limited to any metadata or other identifier information that a user provides when storing or categorizing streaming videos.

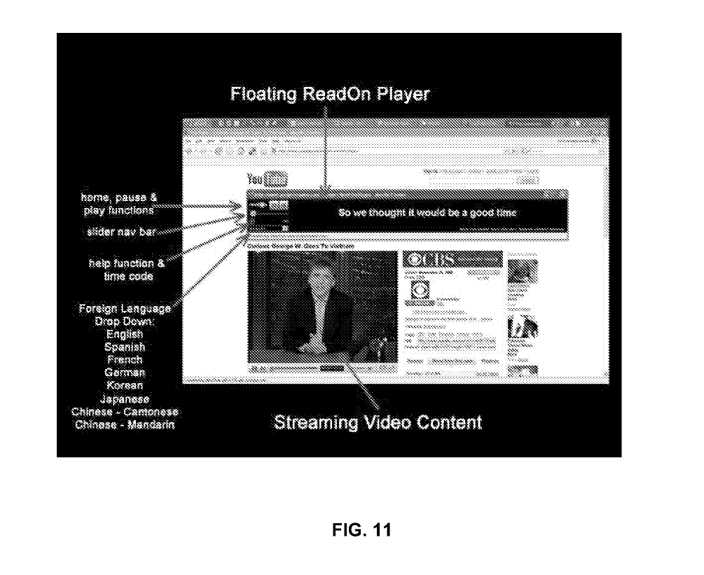

FIG. 8 illustrates a sample screen shot of a closed caption video portal webpage according to one example embodiment of the present invention. In this embodiment, the portal webpage, projectreadon.com (Project readOn®), may include a login/sign in link 702 through which an end user may create an account at the closed caption video portal and/or be identified by logging into the account. The portal webpage may also include text submission field 704 where a registered end user may submit a HTML link of a streaming video to the closed caption server for closed captioning. A streaming video player 706 and a frame 708 for displaying synchronized closed caption text may be embedded in the portal webpage. Pushing a Play button may automatically trigger the playing of stream video synchronized with closed caption text display in the frame below the video frame in accordance with an example embodiment of the present invention. At an advertising frame 710, targeted advertisements associated with the streaming video may be displayed.

FIG. 9 illustrates a sample screen shot of a streaming video having text information associated therewith. In this example, the user is presented with a basic viewer, this case being a YouTube viewer as accessible through an internet connection. In conjunction with the display of the streaming video, the user is also presented with a second frame on the screen for showing closed caption text. In this example, a user may select the play button on the video viewer and then immediately select the play button on the text viewer. Thus, as the video plays, the text is also displayed in the same timing sequence.

In embodiments where the browser manages both the text and the video, it is recognized that the browser may synchronize these events. One technique may include using the timing cues discussed above, which may be included in the text file such that when the video reaches designated time points, the text may then be updated. This allows for any delay in the video stream to also delay the text.

FIG. 10 illustrates another screen shot, similar to FIG. 9. In an example embodiment of the present invention, the text window may be moved, as illustrated by a comparison of FIGS. 9 and 10. In FIG. 9, the text window was above the video and in FIG. 10 it is displayed below the video.

The caption information may be readily translated into any number of different languages. Therefore, the user may be able to receive the caption information in a selected language. In an example embodiment, the captioned text display viewer may include a selection menu for the user to select an available language. By way of example, FIG. 11 illustrates a sample screenshot of the streaming video viewer and the text viewer according to an example embodiment of the present invention. The text viewer includes a drop down menu providing a selection of available languages. For example, the text file may include header data or metadata that designates which languages are currently available. Based on this data, the viewer may populate the selection menu. Using any standard type of interface, the viewer may retrieve the text of the selected language. For example, if the user selects for the captioning to be in German, the German-language caption may be displayed instead of a default selection, such as English.

FIGS. 9-11 illustrate the dual display of the streaming video and the text window. It is recognized that these may be integrated into a single browser. An example embodiment includes a stand-alone browser enabled through a general application, such as through a Flash player. The user may be presented with various videos that are text-enabled.

The browser may present the option of viewing text information including the closed caption data and/or other text data for text enabled videos. For example, a news video browser may present a user with video news stories, some of which may be associated with textual news stories. For text enabled videos, a special button may be included allowing the user to access the text information. The selection of this button may thereupon cause the retrieval of the text information and the browser to simultaneously display both.

Accordingly, exemplary embodiments of the present invention provide for generation of, storage of, and/or making retrievable, closed captioning information. Through these operations, the hearing impaired may be afforded the chance to enjoy streaming videos. Additionally, the conversion of the audio into text-based information may allow for the captioning to be easily translated to many different languages and may also allow streaming video content to be searched based on the audio information associated with the video. It is also noted that while described herein relative to primarily video content, the present invention is fully operative to work, using the same underlying principle described herein, with non-streaming video content having an audio component, such as audio broadcast.

The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the invention. It should be understood that there exist implementations of other variations and modifications of the invention and its various aspects, as may be readily apparent to those of ordinary skill in the art, and that the invention is not limited to the specific embodiments described herein. It is therefore contemplated to cover any and all modifications, variations or equivalents that fall within the scope of the basic underlying principals disclosed and herein.

What is claimed is:

1. A method for providing a video with closed captioning, comprising:
providing, by a first website, a user interface adapted for receiving a user request for generation of closed captioning text, the request referencing a multimedia data file including the video and provided by a second website; and
responsive to the user request:
at least substantially transcribing audio associated with the video into a series of closed captioning text strings arranged in a text file;
for each of the text strings, storing in the text file respective data associating the text string with a respective portion of the video; and
storing for retrieval in response to a subsequent request made to the first website:
the text file; and
a pointer associated with the text file and referencing the multimedia data file.

2. The method of claim 1, further comprising:
responsive to the subsequent request, the first website retrieving the text file and retrieving the video in accordance with the pointer and by accessing the second website; and
displaying the video and the text strings, each text string being displayed during display of the respective portion of the video with which the text string is associated.

3. The method of claim 2, wherein the video is a steams over a communication network.

4. The method of claim 3, wherein the communication network is the Internet.

5. The method of claim 2, further comprising:
assigning cue points at regular intervals to the video; and
playing the video, wherein at the cue points, a remote caption player embedded in the first website generates events that synchronously trigger updates of the closed captioning text.

6. The method of claim 1, further comprising:
providing the text file to an Internet advertisement engine for obtaining an advertisement based on the text file; and
displaying the advertisement along with the video.

7. The method of claim 6, wherein the advertisement engine is Google's AdSense service.

8. The method of claim 1, wherein the closed captioning data includes a closed captioning text file and a metadata, wherein the metadata provides information regarding the streaming video.

9. The method of claim 8, wherein the metadata includes information relating to one or more names of television shows contained in the streaming video, original air dates of the television shows, and summaries of the television shows.

10. The method of claim 1, wherein a speech-to-text program is used for the transcription.

11. The method of claim 1, further comprising prior to the transcription, examining content of the video for a determination whether to generate the closed captioning text based on the content.

12. The method of claim 11, wherein the determination is based on a preset standard for media content.

13. The method of claim 1, wherein the user is identified to the first website by logging into a user-created account at the first website so that the first website associates the user as a requester for the closed captioning text.

14. The method of claim 1, wherein the end user submits the request for closed captioning in a text dialog box at the first website.

15. A method for providing a video with closed captioning, comprising:
providing, by a first website, a user interface adapted for receiving a request for generation of closed captioning text, the request including the video; and
responsive to the user request:
storing the video;
at least substantially transcribing audio associated with the video into a series of closed captioning text strings arranged in a text file;
for each of the text strings, storing in the text file respective data associating the text string with a respective portion of the video; and
storing for retrieval in response to a subsequent request made to the first website:
the text file; and
a pointer associated with the text file and referencing the stored video.

16. The method of claim 15, further comprising:
responsive to the subsequent request, the first website retrieving the text file and retrieving the video in accordance with the pointer; and
displaying the video and the text strings, each text string being displayed during display of the respective portion of the video with which the text string is associated.

17. A method for providing a display of a video, comprising:
transcribing audio associated with the video into a text file;
providing the text file to an advertisement engine for obtaining an advertisement based on the text file; and
displaying the advertisement along with the video.

18. A system for providing a video with closed captioning, comprising:
a database; and
a processing unit configured to:
provide a first website including a user interface adapted for receiving a user request for generation of closed captioning text, the request referencing a multimedia data file that includes the video and is provided by a second website;
in response to the user request:
obtain a transcription that at least substantially transcribes audio associated with the video into a series of closed captioning text strings arranged in a text file that includes for each of the text strings respective data associating the text string with a respective portion of the video; and
store in the database for retrieval in response to a subsequent request made to the first website:
the text file; and
a pointer associated with the text file and referencing the multimedia data file.

19. A computer-readable medium having stored thereon instructions executable by a processor, the instructions which, when executed, cause the processor to perform a method for providing a video with closed captioning, the method comprising:
providing, by a first website, a user interface adapted for receiving a user request for generation of closed captioning text, the request referencing a multimedia data file including the video and provided by a second website; and
responsive to the user request:
at least substantially transcribing audio associated with the video into a series of closed captioning text strings arranged in a text file;
for each of the text strings, storing in the text file respective data associating the text string with a respective portion of the video; and
storing for retrieval in response to a subsequent request made to the first website:
the text file; and
a pointer associated with the text file and referencing the multimedia data file.
